(19) United States
(12) Patent Application Publication
(10) Pub. No.: US 2022/0266999 A1
(43) Pub. Date: Aug. 25, 2022

(54) SCALABLE MODULAR PLATFORM FOR DEVELOPING MULTI-PURPOSE MANNED AND UNMANNED VEHICLES

(71) Applicant: Hugh Bryan Welcel, Winter Park, FL (US)

(72) Inventor: Hugh Bryan Welcel, Winter Park, FL (US)

(21) Appl. No.: 17/555,440

(22) Filed: Dec. 18, 2021

Related U.S. Application Data
(60) Provisional application No. 63/129,090, filed on Dec. 22, 2020.
(60) Provisional application No. 63/185,038, filed on May 6, 2021.
(60) Provisional application No. 63/184,317, filed on May 5, 2021.

(51) Int. Cl. B64C 37/00; B64C 29/00; B64C 1/06

(52) U.S. Cl. CPC B64C 37/00; B64C 29/0025; B64C 1/061; B64C 2211/00

(57) ABSTRACT

The present disclosure provides a modular and scalable platform for the development of land and/or flying multi-purpose manned and unmanned vehicles. The platform including a plurality of parts is provided for structural support, wherein the parts include beams, joints and panels interconnected for forming the platform, a plurality of components is connected to the platform for providing propulsion, a plurality of equipment is connected to the platform for generating mobility in air and land, and navigating the vehicle, wherein the equipment include wings, wheels, landing gears, telemetry equipment, sensors, receivers, transmitters, battery systems, fuel tank, onboard computers, servos, actuators, engines, avionics, direction controls and a case provided for enclosing the platform.

The present application claims priority from the following provisional applications bearing provisional application No. 63/129,090, 63/184,317 and 63/185,038.

### FEILD

The embodiments herein generally relate to flying and/or land multi-purpose manned and unmanned vehicles. More particularly, the disclosure relates to a platform of modular and scalable design and characteristics, for developing multi-purpose land and/or flying capable manned and unmanned vehicles.

### BACKGROUND AND PRIOR ART

Presently, green energy sources are a preferred source of energy for usage in the development of any type of vehicle. Electrical energy as a source is largely adapted for development through various means such as generating electrical energy by processing elements like hydrogen for charging a battery system, supplying direct energy to electrical motors and/or other devices.

A vehicle includes a strong structure for withstanding the forces acting on the vehicle and supporting the principal components of the vehicle including engines, fuel tanks, suspensions and many others. The strong structure is called as a chassis in the automotive industry, wherein the chassis is a single platform that is designed for being used in different models of vehicles thereby reducing the production cost.

However, there is no similar platform for the development of aircraft, in the aviation industry. There are newer environmental friendly aircrafts under development which also include Vertical/Short takeoff and landing capabilities (VTOL/STOL). These newer aircrafts are economically accessible thereby causing a high demand and high expectations in the transportation sector. Also, there are newer technologies for increasing efficiency of propulsion systems through introduction of stronger and lighter materials, additive manufacturing process, computer controller systems, the use of electric power sources and other alternative energy sources.

Therefore, there is a need for developing modular and scalable platforms adapted to current transportation requirements. Moreover, there is a need for a novel modular and scalable platform for development of land and/or flying or mixed configuration multi-purpose manned and unmanned platform for both the aviation and automotive industry, with reduced production costs and facilitating development of flying cars.

### OBJECTS

Some of the objects of the present disclosure are described herein below:

A main objective of the present disclosure is to provide a modular and scalable platform for the development of flying/land multi-purpose manned and unmanned vehicles.

Another objective of the present disclosure is to provide a modular and scalable platform for the development of flying/land multi-purpose manned and unmanned vehicles with energy sources being full electric, fueled, mixed or other alternative energy sources.

Yet another objective of the present disclosure is to provide a modular and scalable platform wherein the flying vehicles to be developed can be Vertical/Short Takeoff and Landing (VTOL/STOL) capable.

Still another objective of the present disclosure is to provide a modular and scalable platform for developing a land vehicle, a flight capable vehicle or mixed configuration, with the assembly of multiple parts and components according to the vehicle design.

Yet another objective of the present disclosure is to provide a modular and scalable platform with capability of disassembling the vehicle and platform and reusing for assembling a different vehicle through addition or removal of the parts.

Still another objective of the present disclosure is to provide a modular and scalable platform with plurality of propulsion systems that can be setup in different arrangement along the vehicle as four points, three points and sides of the center of gravity configurations, among others.

Yet another objective of the present disclosure is to provide a modular and scalable platform, wherein the platform is scalable through the addition of parts including a fuselage or any other kind of body (vehicle body);

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a modular and scalable platform for the development of land/flying or mixed configuration multi-purpose manned and unmanned vehicles;

In accordance with an embodiment, the modular scalable platform for developing a vehicle, comprising: a platform provided for structural support including a plurality of parts, wherein the parts including beams, joints and panels interconnected for forming the platform, a plurality of components connected to the platform for providing propulsion, a plurality of equipment connected to the platform for generating mobility, and navigating the vehicle, wherein the equipment including wings, wheels, landing gears, telemetry equipment, sensors, receivers, transmitters, battery systems, fuel tank, onboard computers, servos, actuators, engines, avionics, direction controls and a case provided for enclosing to the platform. In an embodiment, a material of the parts of the platform including high strength and light in weight.

In accordance with an embodiment, the case completely enclosing the platform including a flat surface for facilitating attachment of a vehicle body to the platform.

In accordance with another embodiment, the case partially enclosing the platform for facilitating integration of the vehicle body with platform.

In accordance with an embodiment, the case provided integral to a vehicle body of the vehicle.

In accordance with another embodiment, the case facilitating attachment of a vehicle body to the platform.

In accordance with an embodiment, the components including one or a combination of vector thrust mechanism, thrusters, fluidic thrusters, ducted fans, rotors, jet engines, thrusters, fluidic thrusters, shrouded rotors and wheels for providing propulsion to the vehicle.

In accordance with an embodiment, the components including vector thrust propulsion for providing capability of vertical takeoff and landing and/or short takeoff and landing to the vehicle. In an embodiment, the vector thrust mechanism providing vertical flight capability to the vehicle.

In accordance with an embodiment, the components constituting a propulsion system integrated to the platform for providing mobility of the vehicle in land, air and combination of mobility in land and air.

In accordance with an embodiment, an energy source integrated with the platform for providing energy to the components for propulsion and the equipment and the energy source including one of a fuel source, electric source including battery system and renewable energy source.

In an embodiment, a geometry, dimensions and cross-sectional shape of the parts based on assembly, disassembly and interconnection with the parts.

In accordance with an embodiment, a vehicle body attached externally to the platform for developing the vehicle. In accordance with another embodiment, a vehicle body integrated with the platform for developing the vehicle.

In accordance with an embodiment, the platform capable of mobility independent of a vehicle body.

In accordance with an embodiment, a vehicle can be designed and developed with a modular and scalable platform for transportation of persons, goods, cargo, ambulance, law enforcement, search and rescue, surveillance, and others transportation according to developer requirements.

In accordance with an embodiment, the modular and scalable platform including parts made of lightweight and high-strength materials including but not limited to carbon fiber, aluminum for forming a modular and scalable platform structure as beams of different shapes, joints of different shapes, floor and panel structures of different shapes, bolts and nuts of different sizes, fast relief connectors for interconnection in a plurality of configurations. The platform including external components including but not limited to battery systems, propulsion system, sensors, gauges, indicators, control systems, onboard computers for developing a fully functional modular and scalable platform for land and/or air mobility vehicle.

In accordance with an embodiment, parts, components and equipments of the modular and scalable platform attachable, detachable, removable and capable of assembly and disassembly. The parts, components and equipments capable of being replace and interchangeable by different parts, components and equipments. In an embodiment, size, shape, propulsion systems, energy sources, onboard computer, gauges, indicators changeable based on capacity and requirement of vehicle.

In accordance with an embodiment, components for the modular and scalable platforms including but not limited to wheels, thrusters, ducted fan, jet engines, rotors, wings assemblies, landing gears, cameras.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items;

FIG. 1 illustrates an exploded view of a structure of a modular and scalable platform, according to an embodiment herein;

FIG. 2 illustrates a perspective view of a modular and scalable platform, according to an embodiment herein:

FIGS. 3A, 3B, 3C, 3D, 3E, 3F, 3G and 3H illustrate a perspective view of beams and joints for the modular and scalable platform, according to an embodiment herein;

FIGS. 4A, 4B, 4C, 4D, 4E, 4F, 4G, 4H and 4I illustrate perspective view of components for the modular and scalable platform, according to an embodiment herein;

FIG. 5 illustrates a perspective view of a modular and scalable platform, according to another embodiment herein;

FIG. 6 illustrates a perspective view of a modular and scalable platform according to another embodiment herein;

FIG. 7 illustrates a perspective view of a modular and scalable platform according to another embodiment herein;

FIG. 8 illustrates a perspective view of a modular and scalable platform according to another embodiment herein:

FIG. 9 illustrates a perspective view of a modular and scalable platform, according to another embodiment herein;

FIG. 10 illustrates a perspective view of a modular and scalable platform according to another embodiment herein;

FIG. 11 illustrates a perspective view of a modular and scalable platform according to another embodiment herein:

FIG. 12 illustrates a perspective view of a modular and scalable platform according to another embodiment herein;

FIG. 13 illustrates a perspective view of a modular and scalable platform, according to another embodiment herein;

FIG. 14 illustrates a perspective view of a modular and scalable platform according to another embodiment herein:

FIG. 15 illustrates a perspective view of a modular and scalable platform according to another embodiment herein;

FIG. 16 illustrates a perspective view of a modular and scalable platform according to another embodiment herein;

FIG. 17 illustrates a perspective view of a modular and scalable platform, according to another embodiment herein:

FIG. 18 illustrates a perspective view of a modular and scalable platform according to another embodiment herein;

FIG. 19 illustrates a perspective view of a modular and scalable platform according to another embodiment herein;

FIG. 20 illustrates a perspective view of a modular and scalable platform according to another embodiment herein;

FIG. 21 illustrates a perspective view of a modular and scalable platform, according to another embodiment herein:

FIG. 22 illustrates a perspective view of a modular and scalable platform according to another embodiment herein;

FIG. 23 illustrates a perspective view of a modular and scalable platform according to another embodiment herein;

FIG. 24 illustrates a perspective view of a modular and scalable platform according to another embodiment herein:

FIG. 25A, 25B, 25C illustrates a modular and scalable platform for developing wingless flying cars, according to an embodiment herein:

FIG. 26A, 26B, 26C illustrates a modular and scalable platform for developing winged flying cars, according to an embodiment herein;

FIG. 27A illustrates a perspective view of a modular and scalable platform, according to another embodiment herein:

FIG. 27B illustrates an inside perspective view of the modular and scalable platform of FIG. 27A according to an embodiment herein:

FIG. 28 illustrates a perspective view of the modular and scalable platform 100 of FIG. 27A with the vehicle body according to an embodiment herein; and

FIG. 29 illustrates a perspective view of a modular and scalable platform according to another embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein;

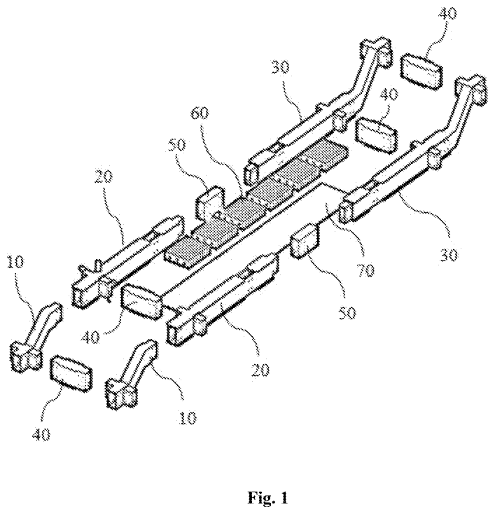

As mentioned above, there is a need for developing modular and scalable platforms adapted to current transportation requirements. In particular, there is a need for a novel modular and scalable platform for development of land and/or flying or mixed configuration multi-purpose manned and unmanned platform for both the aviation and automotive industry, with reduced production costs and facilitating development of flying cars. The embodiments herein achieve this by providing “A Scalable Modular Platform for Developing Multi-Purpose Manned and Unmanned Vehicles”. Referring now to the drawings, and more particularly to FIG. 1 through FIG. 29, where similar reference characters denote corresponding features consistently throughout the figures, there are shown preferred embodiments;

FIG. 1 illustrates an exploded view of a structure of a modular and scalable platform. In an embodiment, the platform includes a plurality of parts. The parts including plurality of beams 10, 20, 30, plurality of joints 40, 50 and a battery system 60. In an embodiment, the joints 40, 50 are provided for connecting and joining the beams 10, 20, 30 for forming an assembly with different configurations. A panel 70 is provided for housing the battery system 60. The beams 10, 20, 30, joints 40, 50 and the panel 70 include a design with a geometry for facilitating interconnection between each other in multiple ways thereby generating assemblies in multiple configurations. In an embodiment, the parts are built with a strong material and light in weight. The interconnected parts are secured using fasteners. The fasteners including but not limited to bolts, nuts.

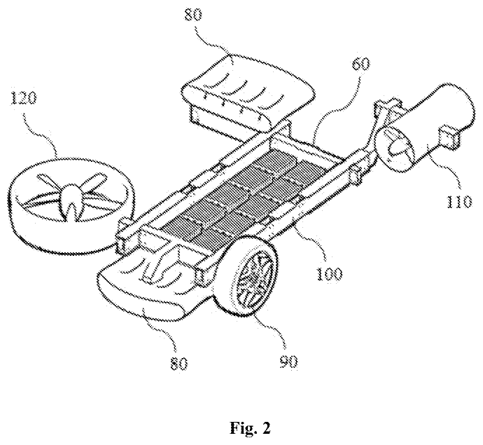

FIG. 2 illustrates a perspective view of a modular and scalable platform, according to an embodiment herein. In an embodiment, the modular and scalable platform 100 includes beams, joints and a panel. The platform is connected to one or a combination of a plurality of components. The components including but not limited to a battery system 60, onboard computers, wheel 90, and power sources. The power sources include but not limited to shrouded rotors 120, ducted fans, jet engines, thrusters 80, 110 and fluidic thrusters. The components are connected to the platform through designed adapters and/or customized elements. In an embodiment, a plurality of equipment connected to the platform for generating mobility, and navigating the vehicle. The equipment including but not limited to wings, wheels, landing gears, telemetry equipment, sensors, receivers, transmitters, battery systems, fuel tank, onboard computers, servos, actuators, engines, avionics, and direction control.

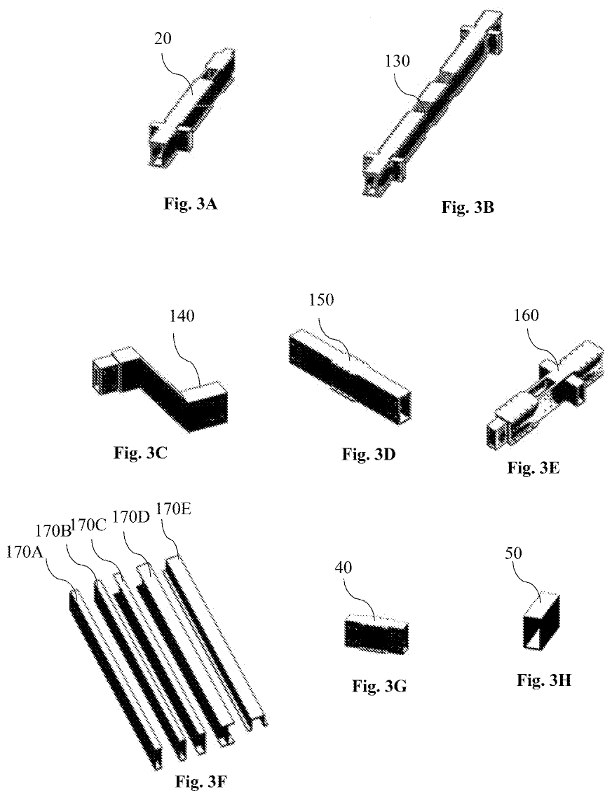

FIGS. 3A, 3B, 3C. 3D, 3E, 3F, 3G and 3H illustrate a perspective view of beams and joints for the modular and scalable platform. The beams and joints are provided for assembling modular and scalable platform. In an embodiment, beams and joints include designs with different geometries capable of joining with each other. Each part of the platform is developed for accomplishing at least one function. In an embodiment, FIG. 3A, FIG. 3B, FIG. 3C, FIG. 3D and FIG. 3E illustrates beams 20, 130, 140, 150 and 160 with different dimensions, cross-sectional areas, connecting portions, shapes and geometries based on requirement of the vehicle. FIG. 3F illustrates plurality of beams 170A, 170B, 170C, 170D, 170E with different cross sectional shapes and dimensions. FIG. 3G and FIG. 3H illustrate joints 40, 50 for joining the beams.

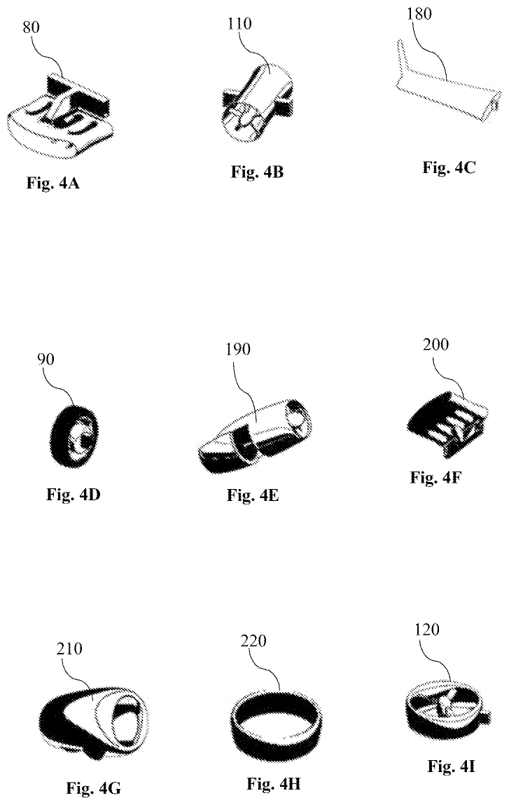

FIGS. 4A, 4B, 4C, 4D, 4E, 4F, 4G, 4H and 4I illustrate perspective view of components for the modular and scalable platform. In an embodiment, FIG. 4A illustrates the thruster 80 for propulsion, FIG. 4B illustrates the thruster 110 for propulsion according to another embodiment, FIG. 4C illustrates a wing 180 for flying the vehicle. FIG. 4D illustrates the wheel 90 for mobility of the vehicle on land, FIG. 4E illustrates a thruster 190 for propulsion according to another embodiment, FIG. 4F illustrates a thruster 200 for propulsion according to another embodiment, FIG. 4G illustrates a thruster 210 for propulsion according to another embodiment, FIG. 4H illustrates a fluidic thruster 220 for propulsion and FIG. 4I illustrates the shrouded rotor 100. In an embodiment, one or a combination of the components is connected to the platform for flying and/or driving the vehicle on land and/or air.

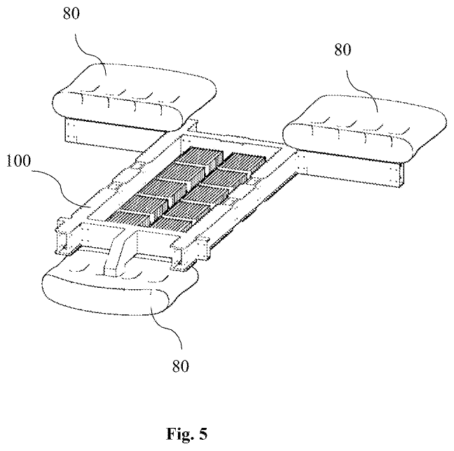

FIG. 5 illustrates a perspective view of a modular and scalable platform, according to another embodiment. The modular and scalable platform includes one thruster 80 provided at a front portion and two thrusters provided at a rear portion of the platform. The one thruster 80 is connected to a bottom of the platform at the front portion and the thrusters 80 at the rear portion include one thruster 80 connected at top of left side and the other thruster 80 connected at top of right side of the platform 100.

In an embodiment, the platform includes one or a combination of components for propulsion including vector thrust mechanism, a battery system, wings, thrusters, wheels, ducted fans and fluidic thrusters. Dimensions, shapes and geometries of the components based on function, requirement and connection with the platform. In an embodiment, the components for propulsion including the vector thrust mechanisms specified in the non-provisional United States Patent and Trademark Office (USPTO) patent application number U.S. Ser. No. 17/510,017 and Patent Cooperation Treaty (PCT) patent application number PCT/IB2021/059867. The vector thrust mechanisms can be attached to the platform in different locations based on requirement. In an embodiment, the platform includes plurality of configurations based on requirements. The platform capable of facilitating setup for development of flying vehicle, land vehicle, vehicle with capacity of flying land mobility. In an embodiment, the vehicles including manned vehicles and unmanned vehicles. In an embodiment, a vehicle body externally attached to the platform with the components and equipment. In an embodiment, a vehicle body integrated with the platform with the components and equipment. In an embodiment, the equipment including conventional system provided in vehicles such as cars, aircrafts for facilitating land mobility and air mobility.

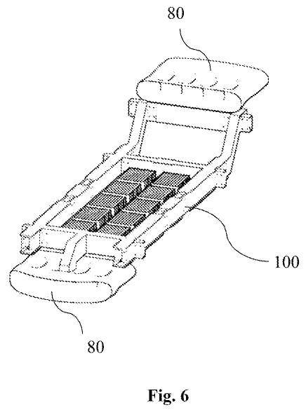

FIG. 6 illustrates a perspective view of a modular and scalable platform according to another embodiment. The modular and scalable platform 100 includes the thruster 80 provided at a front portion and the thruster 80 provided at a rear side. The thruster 80 at the front portion is connected to a bottom of the platform 100 and the thruster at the rear portion is connected to a top of the platform.

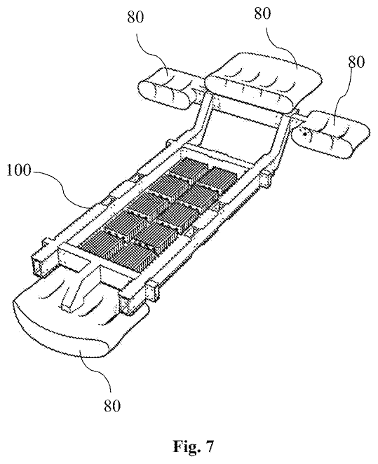

FIG. 7 illustrates a perspective view of a modular and scalable platform according to another embodiment. The modular and scalable platform 100 includes one thruster 80 provided at a front side, three thrusters provided at a rear portion of the platform 100. The thruster 80 at the front portion is connected to a bottom of the platform 100 and the thrusters 80 includes one thruster connected at left side, one thruster connected at right side and the other thruster 80 connected in the middle at a top of the platform.

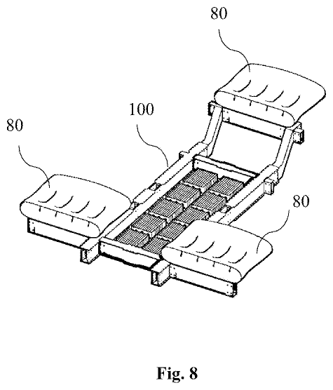

FIG. 8 illustrates a perspective view of a modular and scalable platform according to another embodiment. The modular and scalable platform 100 includes two thrusters 80 provided at a front portion of the platform and one thruster 80 provided at a rear portion of the platform 100. The two thrusters 80 includes one thruster connected at top of left side and the other thruster 80 connected at top of right side of the platform. The one thruster 80 is connected at top of the platform 100 at the rear side.

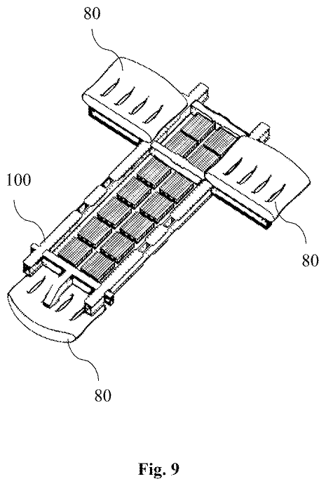

FIG. 9 illustrates a perspective view of a modular and scalable platform according to another embodiment. The modular and scalable platform 100 includes one thruster 80 provided at a front portion of the platform 100 and two thrusters 80 provided at a rear portion of the platform 100. The one thruster 80 is connected to a bottom of the platform 100 and the two thrusters 80 includes one thruster 80 connected at top of left side of the platform 100 and one thruster 80 connected at top of right side of the platform 100.

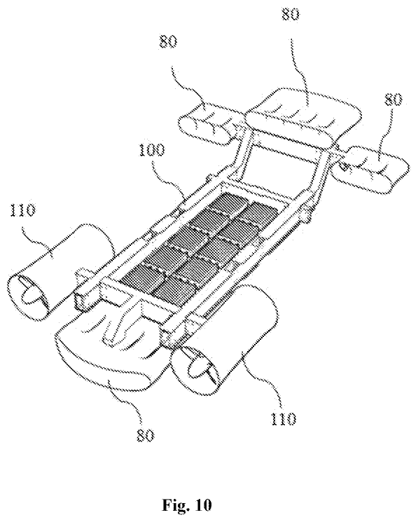

FIG. 10 illustrates a perspective view of a modular and scalable platform according to another embodiment. The modular and scalable platform 100 includes one thruster 80 and thrusters 110 provided at a front portion and three thrusters 80 provided at a rear side. The thruster 80 at the front portion is connected to a bottom of the platform 100, the thrusters 110 include one thruster 110 connected to left side of the platform 100 and the other thruster 100 connected to right side of the platform 100. The thrusters at the rear portion include one thruster 80 connected to left side of the platform, one thruster 80 connected to right side of the platform 100 and the other thruster connected at a top in a middle of the platform 100.

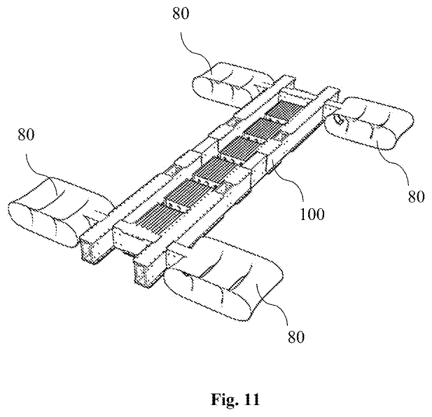

FIG. 11 illustrates a perspective view of a modular and scalable platform according to another embodiment. The modular and scalable platform 100 includes two thrusters 80 provided at a front portion and two thrusters 80 provided at a rear side. The two thrusters 80 at the front portion include one thruster connected to a left side and the other thruster connected to a right side of the platform. The two thrusters 80 at the rear portion include one thruster connected to a left side and the other thruster connected to a right side of the platform.

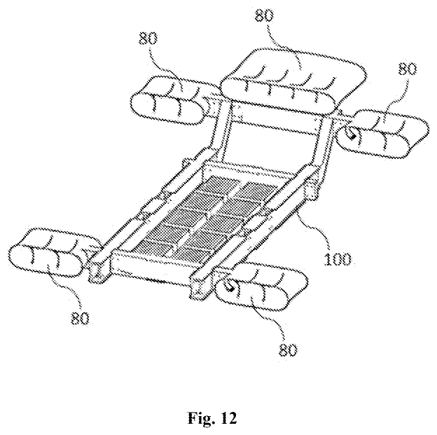

FIG. 12 illustrates a perspective view of a modular and scalable platform according to another embodiment. The modular and scalable platform 100 includes thrusters 80 provided at a front portion and thruster 80 provided at a rear side. The thruster 80 at front portion includes one thruster 80 connected to left side of the platform and the other thruster 80 connected to right side of the platform. The thrusters 80 at the rear portion includes one thruster 80 connected to left side of the platform, one thruster 80 connected to right side of the platform and the other thruster 80 connected at top of middle of the platform 100.

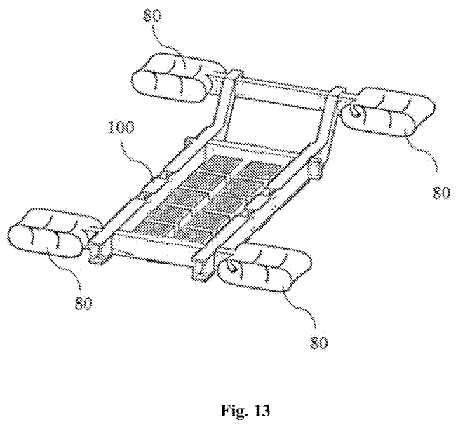

FIG. 13 illustrates a perspective view of a modular and scalable platform according to another embodiment. The modular and scalable platform 100 includes two thrusters 80 provided at a front portion and two thrusters 80 provided at a rear side. The thrusters 80 at the front portion include one thruster connected to left side of the platform and the other thruster 80 connected to right side of the platform. The thrusters 80 at the rear portion include one thruster connected to left side of the platform and the other thruster 80 connected to right side of the platform.

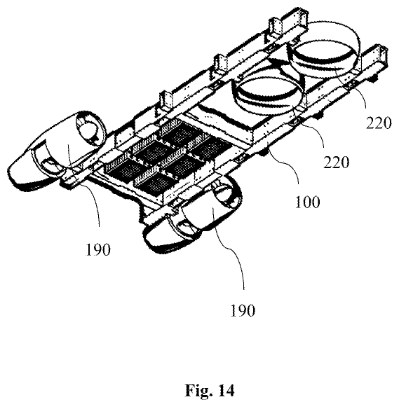

FIG. 14 illustrates a perspective view of a modular and scalable platform according to another embodiment. The modular and scalable platform 100 includes fluidic thrusters 220 embedded at a front portion of the platform and thrusters 190 at a rear portion of the platform. The thrusters 190 include one thruster 190 connected to left side of the platform and the other thruster 190 connected to right side of the platform.

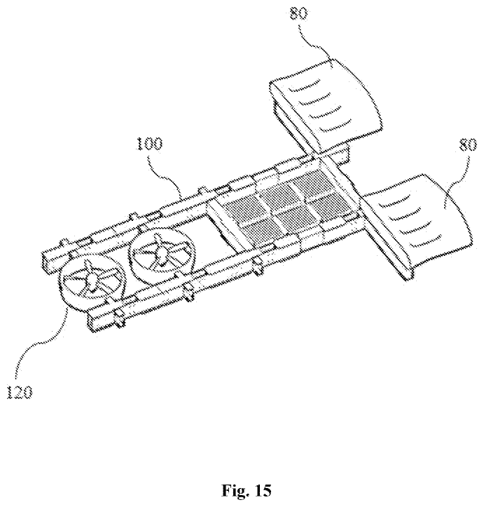

FIG. 15 illustrates a perspective view of a modular and scalable platform according to another embodiment. The modular and scalable platform 100 includes shrouded rotors 120 embedded to the platform 100 at a front portion and thrusters 80 connected at rear portion of the platform 100 including one thruster 80 connected to left side and the other thruster 80 connected to right side of the platform 100.

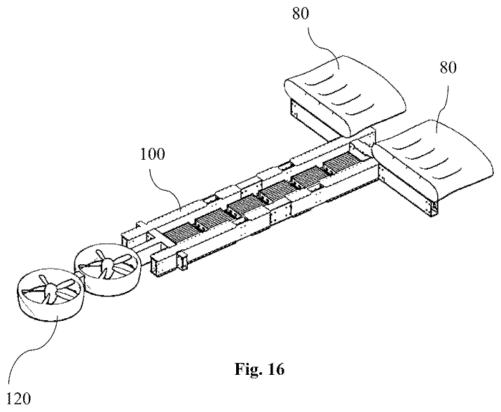

FIG. 16 illustrates a perspective view of a modular and scalable platform according to another embodiment. The modular and scalable platform 100 includes shrouded rotors 120 connected to the platform 100 at a front portion and the thrusters 80 connected to the platform at a rear side. The thrusters 80 include one thruster 80 connected at a top of the left side of the platform and the other thruster connected at a top of the right side of the platform.

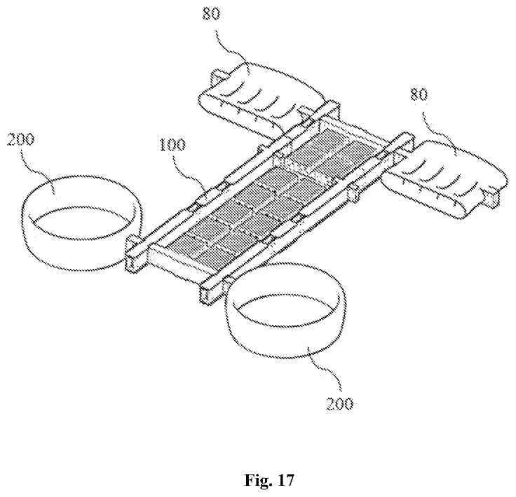

FIG. 17 illustrates a perspective view of a modular and scalable platform according to another embodiment. The modular and scalable platform 100 includes the fluidic thrusters 220 connected to a front portion of the platform and the thrusters 80 connected to a rear portion of the platform. The fluidic thrusters 220 include one fluidic thruster 220 connected to a left side and the other fluidic thruster 220 connected to a right side of the platform 100. The thrusters 80 include one thruster 80 connected to a left side and the other thruster 80 connected to a right side of the platform 100.

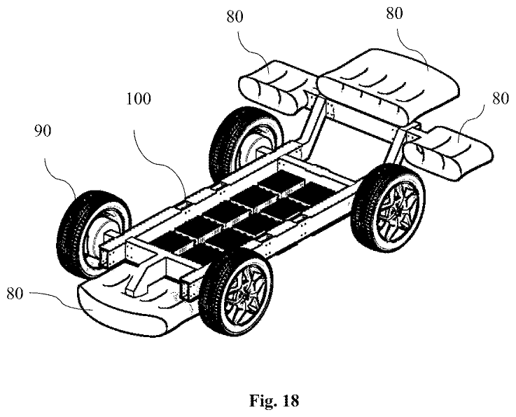

FIG. 18 illustrates a perspective view of a modular and scalable platform according to another embodiment. The modular and scalable platform 100 includes wheels 90 connected to the platform 100 for facilitating mobility of the vehicle on land. The platform 100 includes thruster 80 provided at a front portion and thrusters 80 provided at a rear side. The thruster 80 at the front portion is connected to a bottom of the platform 100 and the thrusters 80 at the rear portion include one thruster connected to a left side, one thruster connected to a right side and the other thruster connected to a top of middle of the platform 100.

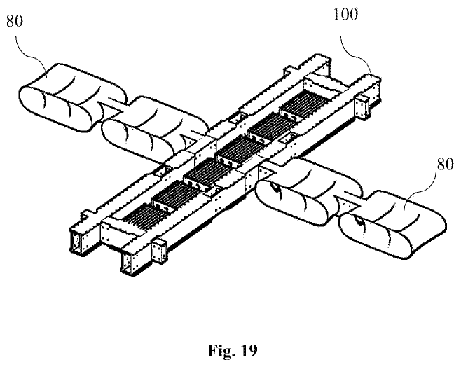

FIG. 19 illustrates a perspective view of a modular and scalable platform according to another embodiment. The modular and scalable platform 100 includes thrusters 80 connected to a left side and thrusters 80 connected to a right side.

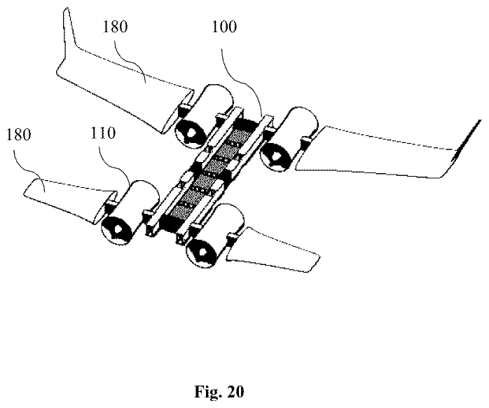

FIG. 20 illustrates a perspective view of a modular and scalable platform according to another embodiment. The modular and scalable platform 100 includes thrusters 110 connected to a left side and right side of the platform 100 at a front portion and rear portion of the platform 100. Wings 180 are connected to the left side and the right side at the front portion of the platform and the rear portion of the platform 100.

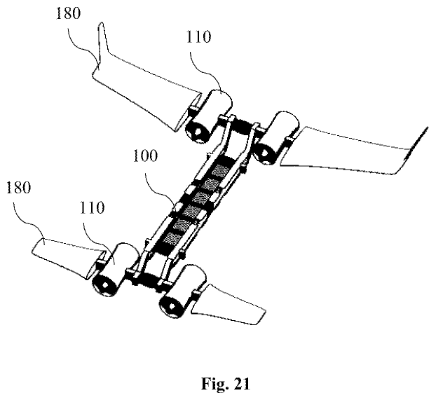

FIG. 21 illustrates a perspective view of a modular and scalable platform according to another embodiment. The modular and scalable platform 100 includes thrusters 110 and wings 180 connected at a front portion at a bottom of the platform 100 and thrusters 110 and wings 180 connected at a rear portion at a top of the platform 100. At the front portion and the rear side, one thruster 110 and wing 180 is connected to a left side and the other thruster 110 and wing 180 is connected to a right side of the platform.

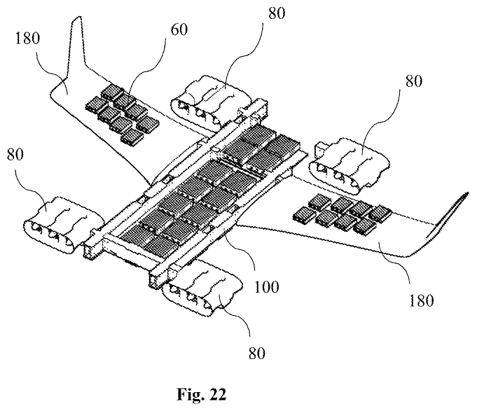

FIG. 22 illustrates a perspective view of a modular and scalable platform according to another embodiment. The modular and scalable platform 100 includes thrusters 80 provided at a front portion of the platform and a rear portion of the platform 100. The thrusters 80 includes one thruster connected to a left side and the other thruster connected to a right side of the platform 100 at the front portion and the rear portion of the platform 100. The platform 100 includes wing 180 with the battery system 60 connected at the left side and the right side between the thrusters 80 at the front portion and the thrusters 80 at the rear side.

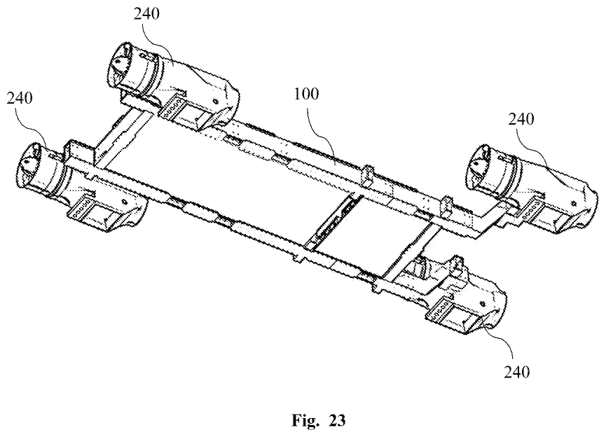

FIG. 23 illustrates a perspective view of a modular and scalable platform according to another embodiment. The modular and scalable platform 100 includes thrusters 240 with vectored thrust capacity at a front portion and a rear side. The platform includes thrusters 240 connected to a left side and a right side at the front portion of the platform and thrusters 240 connected at a top of the left side and the right side of the platform 100 at the rear side.

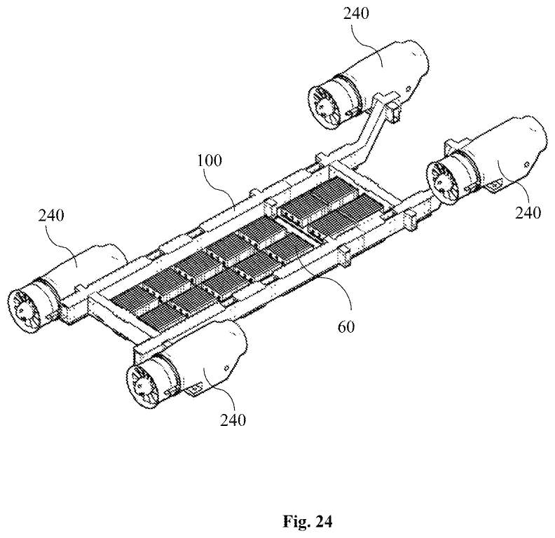

FIG. 24 illustrates a perspective view of a modular and scalable platform according to another embodiment. The modular and scalable platform 100 includes thrusters 240 with vectored thrust capacity at a front portion and a rear side. The platform includes thrusters 240 connected to a left side and a right side at the front portion of the platform and thrusters 240 connected at a top of the left side and the right side of the platform 100 at the rear side.

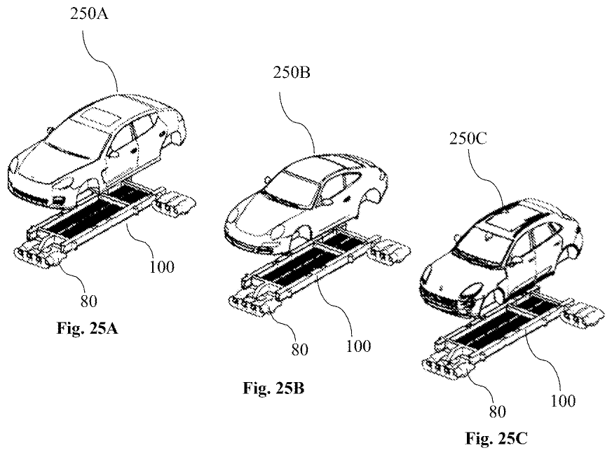

In an embodiment, FIG. 25A, 25B, 25C illustrates wingless flying cars wherein the energy source including but not limited to one of fuel, electric powered battery and environment friendly source.

FIG. 25a illustrates a perspective view of a modular and scalable platform according to another embodiment. The modular and scalable platform 100 includes thrusters 80 at a front portion and a rear portion and a sedan vehicle body 250A on top of the platform 100.

FIG. 25b illustrates a perspective view of a modular and scalable platform according to another embodiment. The modular and scalable platform 100 includes thrusters 80 at a front portion and a rear portion and a sports vehicle body 250B on top of the platform 100.

FIG. 25c illustrates a perspective view of a modular and scalable platform according to another embodiment. The modular and scalable platform 100 includes thrusters 80 at a front portion and a rear portion and a SUV vehicle body 250C on top of the platform 100.

In an embodiment, shape, configuration and dimensions of the vehicle body based on the platform. The vehicle body is capable of being connected to the platform including a case and the platform without a case.

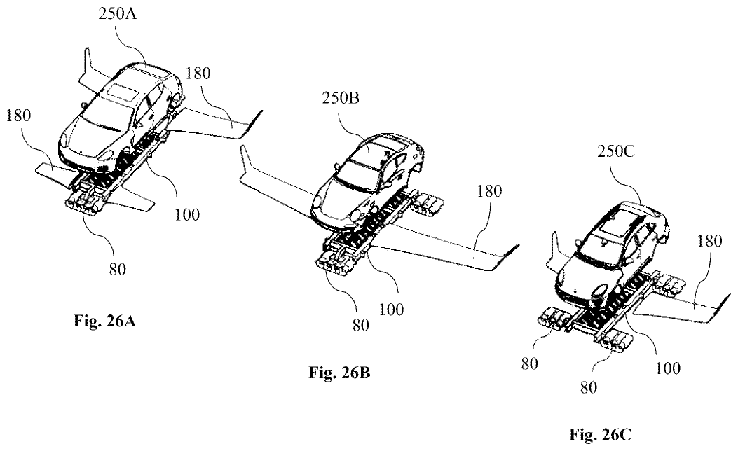

In an embodiment, FIG. 26A, 26B, 26C illustrates winged flying cars wherein the energy source including but not limited to one of fuel, electric powered battery and environment friendly source.

FIG. 26a illustrates a perspective view of a modular and scalable platform according to another embodiment. The modular and scalable platform 100 includes thrusters 80 at a front portion and a rear side, wings 180 at the front portion and the rear portion and the sedan vehicle body 250A on top of the platform 100.

FIG. 26b illustrates a perspective view of a modular and scalable platform according to another embodiment. The modular and scalable platform 100 includes the thruster 80 at a front portion and thrusters 80 connected to a left side and a right side of a rear side, wings 180 connected to the left side and the right side and the sports vehicle body 250B on top of the platform 100.

FIG. 26c illustrates a perspective view of a modular and scalable platform according to another embodiment. The modular and scalable platform 100 includes thrusters 80 connected to a left side and a right side at a front portion and a rear portion of the platform. The platform 100 includes wings 180 connected to the left side and the right side and the SUV vehicle body 250C on top of the platform 100.

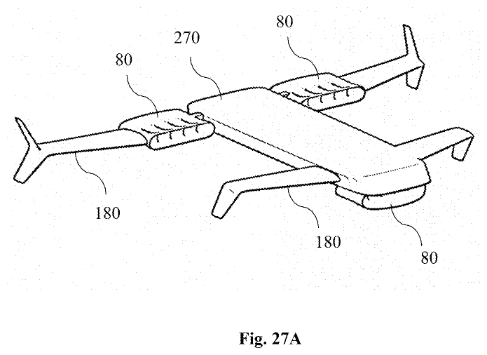

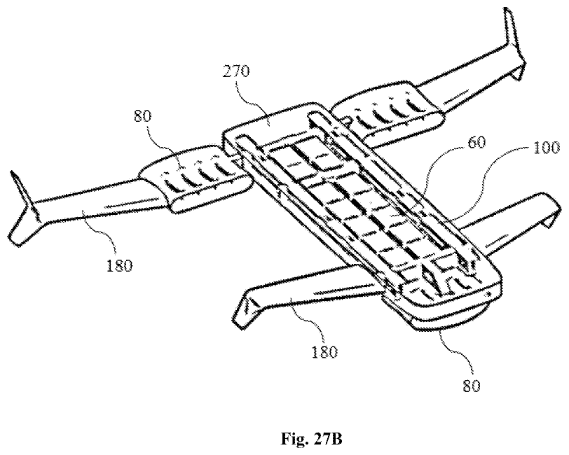

FIG. 27A illustrates a perspective view of a modular and scalable platform according to another embodiment. A case 270 is provided for enclosing the platform. The thruster 80 is connected to a front portion of the platform at a bottom of the case 270 and thrusters 80 connected to a rear portion of the platform at a left side and right side of the case. The thrusters 80 include one thruster connected to the platform at the left side of the case and the other thruster connected to the platform at the right side of the case. The platform includes wings 180 connected to the left side and the right side at the front portion and rear portion of the platform.

FIG. 27B illustrates an inside perspective view of the modular and scalable platform of FIG. 27A. In an embodiment, a shape, design, dimensions and configurations of the case 270 based on the platform configuration. In an embodiment, shape of the case 270 including but not limited to totally covering the platform and partially covering the platform. Surface of the platform including to a flat top surface for attaching a vehicle body on the top of the platform, wherein the platform is fully independent and operable with the vehicle body.

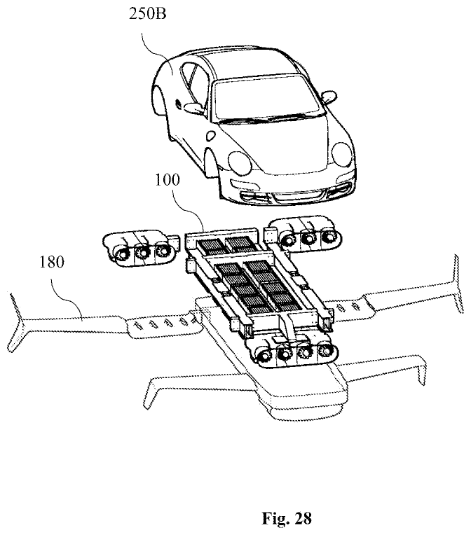

FIG. 28 illustrates a perspective view of the modular and scalable platform 100 of FIG. 27A with the vehicle body. The platform 100 includes the sports vehicle body 250B connected to a top of the platform 100.

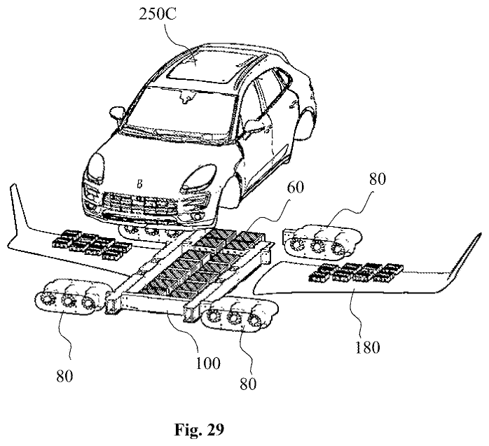

FIG. 29 illustrates a perspective view of a modular and scalable platform according to another embodiment. The platform 100 includes thrusters 80 connected to the platform at a front portion and a rear portion. The thrusters 80 includes one thruster connected to the left side of the platform and the other thruster connected to the right side of the platform 100, at the front portion and the rear portion. One wing 180 is connected to the platform at the left side and the other wing 180 is connected to the platform at the right side. The SUV vehicle body 250C is connected to a top of the platform 100.

A main advantage of the present disclosure is that the platform provides development of manned and unmanned vehicle with capability of flying in air, land mobility and a combination of both.

Another advantage of the present disclosure is that the platform provides development of vehicle in reduced time.

Yet another advantage of the present disclosure is that the platform provides personalization and customization of parts, components and equipment in vehicle development based on requirement.

Still another advantage of the present disclosure is that the platform provides faster assembly and disassembly of vehicles with flying and land mobility capabilities.

Yet another advantage of the present disclosure is that the platform provides a cost-effective development for vehicles with land and air mobility.

Still another advantage of the present disclosure is that the platform provides addition, removal and interchangeability among parts, components and equipment for the development of customized vehicle.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

I claim:

1. A scalable modular platform for developing a vehicle, comprising:
a platform provided for structural support including a plurality of parts;
wherein the parts including beams, joints and panels interconnected for forming the platform;
a plurality of components connected to the platform for providing propulsion;
a plurality of equipment connected to the platform for generating mobility in air and land, and navigating the vehicle;
wherein the equipment including propulsion systems, wings, wheels, landing to gears, telemetry equipment, sensors, receivers, transmitters, battery systems, fuel tank, onboard computers, servos, actuators, engines, avionics, direction controls; and
a case provided for enclosing the platform.

2. The platform as claimed in claim 1, wherein a plurality of propulsion systems that can be setup in different arrangement along the vehicle as four points, three points and sides of the center of gravity configurations, among others.

3. The platform as claimed in claim 1, wherein the case completely enclosing the platform including a flat surface for facilitating attachment of a vehicle body to the platform.

4. The platform as claimed in claim 1, wherein the case partially enclosing the platform for facilitating integration of the vehicle body with platform.

5. The platform as claimed in claim 1, wherein the case provided integral to a vehicle body of the vehicle.

6. The platform as claimed in claim 1, wherein the case facilitating attachment of a vehicle body to the platform.

7. The platform as claimed in claim 1, wherein the components including one or a combination of vector thrust mechanism thrusters, fluidic thrusters, ducted fans, rotors, jet engines, thrusters, fluidic thrusters, shrouded rotors and wheels for providing propulsion to the vehicle.

8. The platform as claimed in claim 1, wherein a material of the parts of the platform consisting strength and light in weight.

9. The platform as claimed in claim 1, wherein the components including vector thrust propulsion for providing capability of vertical takeoff and landing and/or short takeoff and landing to the vehicle.

10. The platform as claimed in claim 1, wherein the components constituting a propulsion system integrated to the platform for providing mobility of the vehicle in land, air and combination of mobility in land and air.

11. The platform as claimed in claim 8, wherein the vector thrust mechanism providing vertical flight capability to the vehicle.

12. The platform as claimed in claim 1, wherein an energy source integrated with the platform for providing energy to the components for propulsion and the equipment; and
the energy source including one of a fuel source, electric source including battery system and renewable energy source.

13. The device as claimed in claim 1, wherein a geometry, dimensions and cross-sectional shape of the parts based on assembly, disassembly and interconnection with the parts.

14. The device as claimed in claim 1, wherein a vehicle body attached externally to the platform for developing the vehicle.

15. The device as claimed in claim 1, wherein a vehicle body integrated with the platform for developing the vehicle.

16. The device as claimed in claim 1, wherein the platform capable of mobility independent of a vehicle body.
